(19) United States
(12) Patent Application Publication
(10) Pub. No.: US 2010/0300397 A1
(43) Pub. Date: Dec. 2, 2010

(54) CONNECTING ROD LUBRICATION RECESS

(76) Inventors: Michael T. Lapp, Bloomfield, MI (US); Dan H. Dinu, Windsor (CA); Roger Krause, Howell, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/476,337

(22) Filed: Jun. 2, 2009

(51) Int. Cl. F16C 7/00; B21D 53/84

(52) U.S. Cl. 123/197.3; 29/888.09

(57) ABSTRACT

A connecting rod and methods of making a rod are disclosed. A method of making a connecting rod may include the step of providing a connecting rod blank, where the connecting rod blank includes a crankshaft end and a piston pin end. The method may further include forming a crankshaft pin recess in the crankshaft end of the connecting rod blank and a piston pin recess in the piston pin end, and forming at least one lubrication recess in the piston pin end of the connecting rod blank. The lubrication recess and the piston pin recess may both formed concurrently.

### BACKGROUND

The traditional internal combustion engine relies on connecting rods for transmitting combustion power from a piston main body to a crankshaft of the engine, thereby converting the linear motion of the piston main body to rotational motion at the crankshaft. Combustion power is generated from the intermittent ignition of gasoline that is injected into the combustion chamber, which creates extreme pressures that are applied to the piston and connecting rod. In particular, the interface between the piston pin bore of the connecting rod and the piston pin experiences continuous radial loads during operation, where only a limited amount of a lubricant may be available for lubricating the interface. In an effort to enhance lubrication at the interface of the piston pin and the connecting rod bore, at least one lubrication recess may be provided along an inner surface of the piston pin bore.

Typically, the lubrication recess is created by machining an indentation into an inner surface of the piston pin bore of the connecting rod. The machining process may be a separate manufacturing operation that occurs after the connecting rod piston pin bore has been created through a material forming operation, such as, for example, forging. Machining operations may add to the expense and the complexity of manufacturing the connecting rod.

Accordingly, there is a need in the art for a connecting rod including a lubrication recess that is relatively cost-effective and simple to manufacture.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1A is an elevated perspective view of an exemplary connecting rod;

FIG. 1B is a side view of the connecting rod shown in FIG. 1A assembled with a piston main body and a piston pin;

FIG. 1C is an enlarged elevational perspective view of a piston pin end of the connecting rod;

FIG. 1D is magnified view of a lubrication recess of the piston pin end of the connecting rod;

FIG. 2A is a side view of an exemplary connecting rod blank;

FIG. 2B is a side view of the connecting rod blank of FIG. 2A after an initial forming operation;

FIG. 2C is a side view of the formed connecting rod blank of FIG. 2B after a subsequent forming operation;

FIG. 2D is a side view of the formed connecting rod blank of FIG. 2C after a subsequent forming operation to produce a connecting rod having a material flash;

FIG. 2E is an enlarged perspective view of the piston pin end of the connecting rod in FIG. 2D;

FIG. 2F is an enlarged perspective view of an alternative illustration of the piston pin end of the connecting rod in FIG. 2D;

FIG. 2G is a side view of a the formed connecting rod of FIG. 2D with the material flash removed from the connecting rod; and

FIG. 3 is a process flow diagram of an exemplary connecting rod forming process.

### DETAILED DESCRIPTION

Reference in the specification to “an exemplary illustration”, an “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

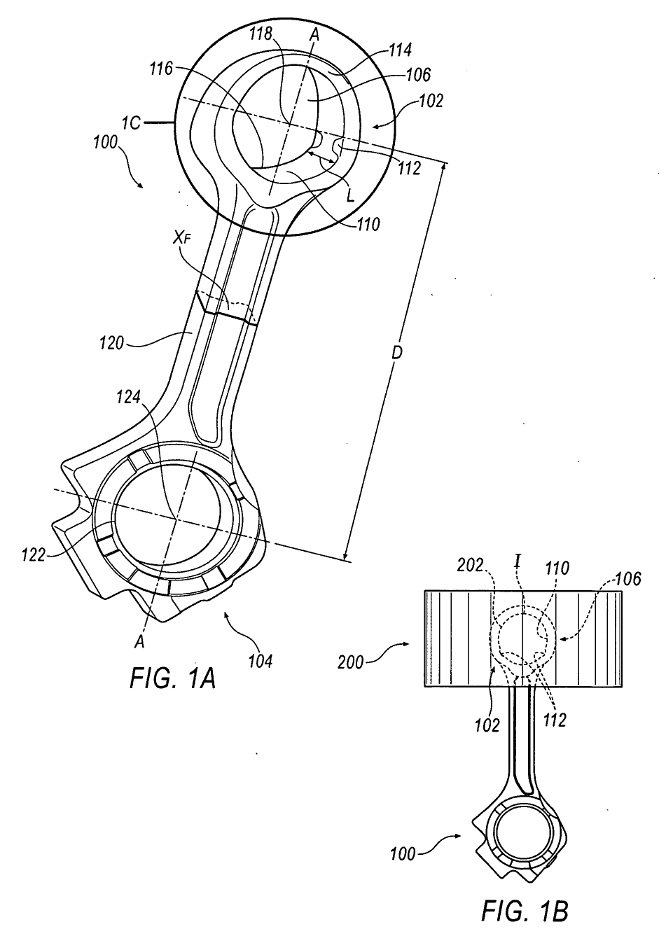

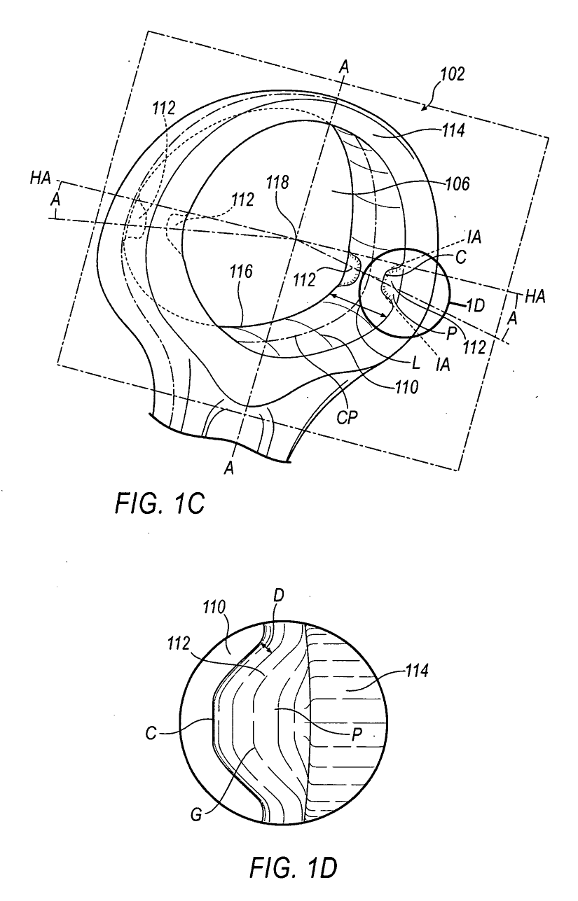

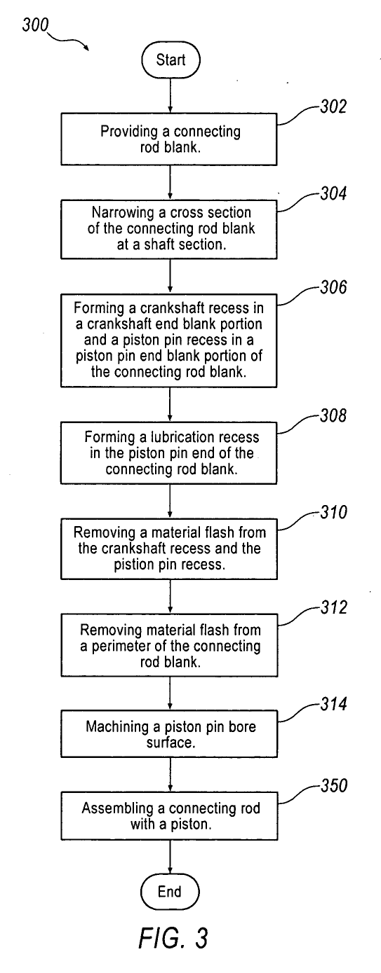

FIG. 1A illustrates an exemplary connecting rod 100. The connecting rod 100 includes a piston pin or small end 102 and a crankshaft or large end 104. The piston pin end 102 includes a piston pin bore 106 that defines a piston pin bore surface 110. The piston pin bore surface 110 includes at least one lubrication recess 112 located at the piston pin bore surface 110. The piston pin bore surface 110 includes a longitudinal surface L that extends between a front face 114 and a rear face 116 of the piston pin end 102. The lubrication recess 112 extends through only a portion of the longitudinal surface L of the piston pin bore surface 110. A method of making the connecting rod 100 is also disclosed at least in FIG. 3, where the lubrication recess 112 and the piston pin end recess 106 may be defined concurrently in forming steps 306 and 308 that create the lubrication recess 112.

Referring back to FIG. 1A, the connecting rod 100 includes a shaft 120 extending between the piston pin end 102 and the crankshaft end 104. The shaft 120 may include a generally I-shaped cross-section X_{F} typical of connecting rods. It should be noted that the cross-section X_{F} of the shaft 120 may include any generally quadrangular section, such as, for example, a square or generally rectangular cross section. The piston pin bore 106 of the piston pin end 102 defines a piston pin bore center 118. The crankshaft or large end 104 generally defines a crankshaft pin bore 122 that has a crankshaft pin bore center 124. The ends 102 and 104 of the connecting rod 100 cooperate to generally define a longitudinal axis A-A of the connecting rod 100.

The piston pin bore surface 110 includes one of more lubrication recesses 112 that extend along only a portion of the longitudinal surface L of the piston pin bore surface 110. The lubrication recesses 112 may be depressions or indentations located in the piston pin bore surface 110. More particularly, the lubrication recesses 112 may be used to accumulate a lubricant, such as, for example, oil or coolant during operation when the connecting rod 100 is assembled in a piston assembly. Turning now to FIG. 1B, as the connecting rod 100 assembled with a piston. More specifically, the connecting rod 100 may be assembled to a piston main body 200 by way of a piston pin 202. In other words, a piston pin 202 may be received in the piston pin end 102 of the connecting rod 100, i.e., within piston pin bore 106, thereby generally securing the connecting rod 100 to the piston 200. In one example the piston 200 may be assembled within a cylinder of an internal combustion engine. An interface I between the piston pin bore 110 of the connecting rod 100 and the piston pin 202 typically experiences continuous radial loads from the piston pin 202 during operation. The lubrication recesses 112 may be provided in an effort to enhance lubrication between the piston pin 202 and the piston pin bore surface 110, as the lubrication typically accumulates within the lubrication recesses 112, thereby increasing the amount of lubrication at the interface I.

FIG. 1C is an enlarged view of the piston pin or small end 102. The piston pin bore surface 110 includes several lubrication recesses 112 that extend along only a portion of the longitudinal surface L such that the lubrication recess 112 intersects only one of the front face 114 and the rear face 116 of the piston pin end 102. That is, the lubrication recess 112 may not generally extend into a central portion CP of the longitudinal surface L, where the central portion CP is illustrated as a plane intersecting the piston pin end 102. The outer surface of the lubrication recesses 112 within the piston pin bore surface 110 may be defined by the outer profile P of the lubrication recess 112. That is, the outer profile P defines the depth and shape of the indentations that create the lubrication recesses 112. In one illustrative example the profile P of the lubrication recesses 112 may include a depth D (illustrated in FIG. 1D) of about 0.019 inches (0.50 mm) within the piston pin bore surface 110.

The lubrication recess 112 may include a generally tapered contour C. The contour C represents a boundary between the piston pin bore surface 110 and the outer profile P of the lubrication recess 112, where the contour C generally indicates the position of the lubrication recess 112. The contour C of the lubrication recesses 112 may be tapered inwardly, towards the central portion CP of the longitudinal surface L. That is, the contour C may be formed at an inward angle IA, oriented towards the central portion CP. It should be noted that while FIGS. 1A and 1C illustrate the contour C of the lubrication recesses 112 having a generally tapered profile, the contour C may include other profiles as well. For example, in one alternative illustration the contour C includes a semi-circular profile.

The contour C may be generally finished in a machining operation that removes material and creates a final finish of the piston pin bore surface 110. That is, the boundary between the piston pin bore surface 110 and the lubrication recess 112 may be substantially defined in a machining operation. It should be noted that while the machining operation of the piston pin bore surface 110 generally defines the contour C, i.e., the boundary between the piston pin bore surface 110 and the lubrication recess 112, the outer profile P of the lubrication recess 112 remains generally unaffected, as the outer profile P is generally defined by the border between the front face 114 and the lubrication recess 112. In other words, a finishing or machining operation working upon the piston pin bore surface 110 may alter the inner contour C while generally leaving the outer profile P unaffected.

FIG. 1C illustrates two lubrication recesses 112 located along the front face 114 generally disposed approximately one hundred and eighty degrees (180°) with respect to each other and two lubrication recesses 112 located along the rear face 116 also 114 generally disposed approximately one hundred and eighty degrees (180°) with respect to each other, where the lubrication recesses 112 located at the front face 114 generally oppose the lubrication recesses 112 on the rear face 116. However, it is understood that other arrangements and any number of lubrication recesses 112 may be provided as well. The lubrication recesses 112 may also be positioned at an angle A measured from a horizontal axis HA of the piston pin bore 106, where the horizontal axis HA may be oriented generally perpendicular to the axis A-A of the connecting rod 100. The angle A may be any angle up to about ninety degrees (90°) in either direction. It should be noted that the lubrication recesses 112 may also be positioned such that the angle A is about zero degrees (0°), that is, the lubrication recesses 112 may be generally aligned with the horizontal axis HA.

In one example, the piston pin bore surface 110 may be generally curved, where the piston pin bore surface 110 includes a substantially convex surface that is curved inwardly towards the piston pin bore center 118 when viewed along the longitudinal surface L. Including a longitudinal surface L that is substantially convex may be advantageous, because the piston pin 202 (illustrated in FIG. 1B) may experience some degree of bending during operation of the piston cylinder assembly 20. A generally curved longitudinal surface L may accommodate at least a portion of the bending of the piston pin 202. The piston pin bore surface 110 may also include an anti-friction coating applied along at least a portion of the piston pin bore surface 110. The anti-friction coating may be any coating that improves wear or scuffing resistance of the piston pin bore surface 110, such as, but not limited to, a manganese-phosphate coating. Moreover, although the piston pin bore 106 is illustrated as a bushingless pin bore, it should be noted that a bushing may be included within the piston pin bore 106 as well, where the lubrication recesses 112 may be formed along a surface of the bushing that contacts a piston pin, such as the piston pin 202 illustrated in FIG. 1B.

At least the piston pin end 102 of the connecting rod 100 may be constructed from a metal based material. Merely as examples, some metals that may be used include steel, aluminum, or titanium. Turning now to FIG. 1D, a magnified illustration of one of the lubrication recesses 112 of the piston pin bore surface 110 illustrates a grain flow G. The grain flow G may be lines located at the surface of the lubrication recess 112 that indicate the orientation of the constituents of the metal when a forming process is used to create the lubrication recess 112.

FIG. 1D illustrates the grain flow G at the lubrication recess 112 oriented to generally correspond to the outer profile P. That is because the lubrication recess 112 may be created by a metal forming process, such as, but not limited to, forging. Metal forming processes typically orient the grain flow G to follow the direction of metal deformation during the forming process. Including a grain structure G that generally follows the direction of metal deformation may result in enhanced material properties, such as, for example, increased strength, ductility, resistance to impact, or fatigue. Creating the lubrication recess 112 by a metal working operation such as forging may be advantageous, especially when compared to a material removal operation, such as machining. This is because machining would not typically orient the grain flow G to be substantially aligned with the outer profile P, because material is only removed during a machining operation. That is, FIG. 1D illustrates the grain flow G as lines that are generally parallel to one another, and are substantially aligned to correspond with the outer profile P. Therefore, machining the outer profile P into the piston pin bore surface 110 would not typically result in the increased material properties that may be experienced during forming.

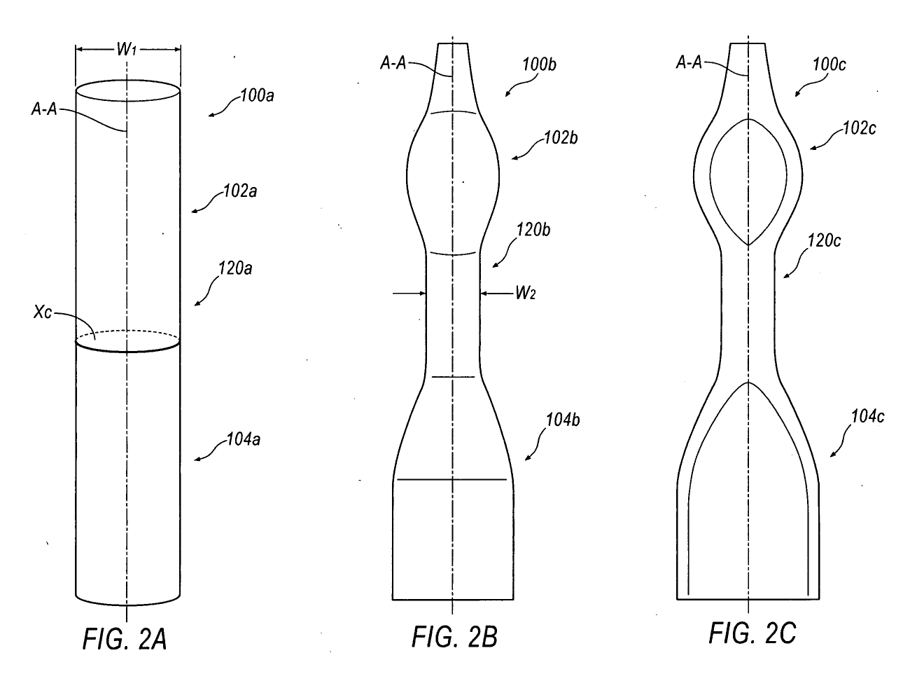

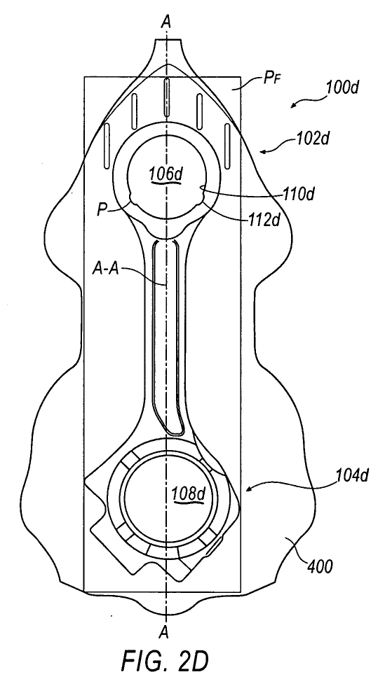

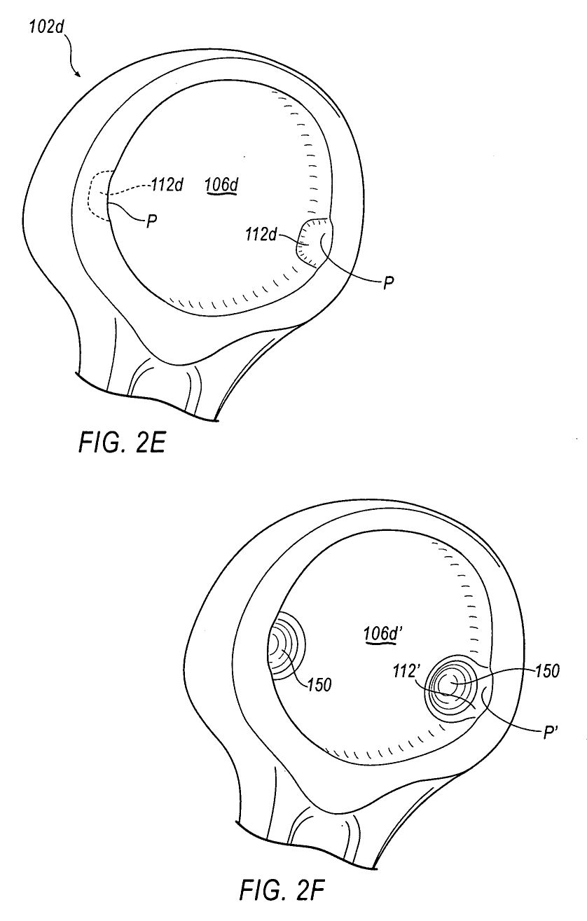

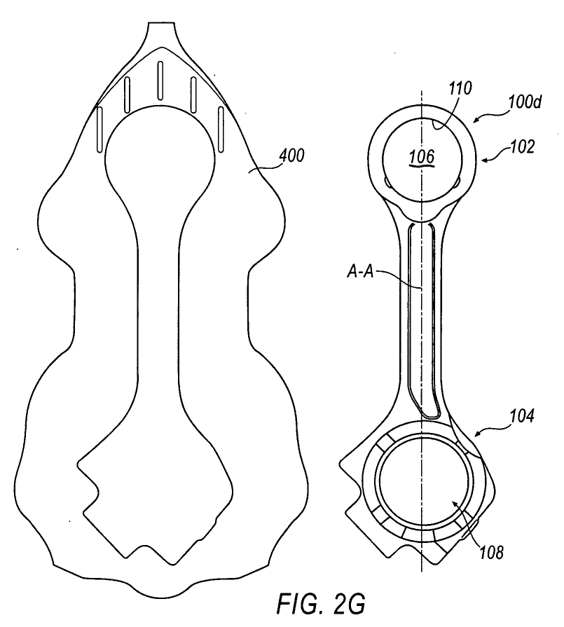

Proceeding to FIGS. 2A-2E, an exemplary process for forming the connecting rod 100 will be described. In FIG. 2A, a connecting rod blank 100a may be provided. The connecting rod blank 100a may include a piston pin end blank portion 102a, a crankshaft end blank portion 104a, and a shaft blank portion 120a. The connecting rod blank 100a may be generally circular in cross-section, which is illustrated as cross section X_{C}. The connecting rod blank 100a may also include a generally uniform cross sectional width W₁.

Turning now to FIG. 2B, the connecting rod blank 100a is narrowed along the connecting rod blank 100a to form a shaft blank portion 120b of a connecting rod 100b. At least a portion of the shaft blank portion 120b may include a narrower cross section, where the cross sectional width W₁, illustrated in FIG. 2A, is generally reduced to a width W₂ in FIG. 2B. In one example, the shaft blank portion 120b may be narrowed by a roll forming operation that generally works directly upon at least a portion of the shaft blank portion 120b.

Referring now to FIG. 2C, a connecting rod blank 100c is shown having a having a generally quadrangular-sectioned piston pin end 102c and crankshaft end 104c. This transitional shape may result from a pre-forging operation that generally forms the connecting rod 100c to a quadrangular-sectioned shape that is generally between the initially round shape shown in FIGS. 2A and 2B, and the final quadrangular-sectioned shape of the connecting rod (e.g., as shown in the perspective view of FIG. 1A). The transitional shape shown in FIG. 2C may allow a subsequent forging or other forming operation to more easily form a desired final shape of the connecting rod 100.

Turning now to FIG. 2D, a connecting rod blank 100d is illustrated after the forming of a piston pin end 102d and the crankshaft end 104d is generally complete, with the exception of initial recesses 106d, 108d. The recesses 106d, 108d have a material flash such that the opening does not extend all the way through the piston pin end 102d or crankshaft end 104d in an axial direction. The material flash is thus subsequently removed to form the bores 106, 108. The blank 100d also includes a material flash 400 generally extending about the perimeter of the connecting rod 100d. As shown in FIG. 2D, the material flash 400 is generally disposed in a plane P_{F} that is generally parallel with the longitudinal axis A-A of the connecting rod 100b. The lubrication recesses 112d may also be formed at the piston pin bore 106d and located along a piston pin bore surface 110d. The formation of the connecting rod 100 is thus generally complete in connecting rod blank 100d, with the exception of the material flash 400 and the material flash within openings 106d and 108d.

FIG. 2E is an enlarged perspective view of the piston pin recess 106d, before the material flash within the recess 106d is removed. The outer profile P of the lubrication recess 112 has been substantially defined by the forming of the piston pin end 102d. That is, the outer profile P of the lubrication recess 112 includes a final predetermined configuration. The final predetermined configuration may be defined as the general overall outer profile P of the lubrication recess 112 included with the substantially complete connecting rod (illustrated in FIGS. 1A-1D and 3E). That is, the final predetermined configuration of the lubrication recesses 112 may be included with the connecting rod 100 assembled to the piston 200, such as the connecting rod and piston assembly illustrated in FIG. 1B. It should be noted that while the outer profile P of the lubrication recesses 112 may be substantially complete before the material flash within the recess 106d is removed, the contour C (FIG. 1C) may be altered or changed in a finishing or machining operation. Specifically, a machining operation removing material and creating the final finish of the piston pin bore surface 110 may still need to occur, thereby defining the contour C of the lubrication recesses 112, while generally not affecting the outer profiles P of the lubrication recesses 112.

In one example, the lubrication recess 112d may be defined in a separate forming operation from the forming of the piston pin recess 106d. That is, the forming of the lubrication recess 112d and the forming of the piston pin bore 106d may be separate operations. Alternatively, in another example the predetermined final configuration of the outer profile P may be defined concurrently with the forming of the piston pin bore 106d.

FIG. 2F is an alternative illustration of a piston pin recess 106d′, where generally circular depressions 150 may be included within the material flash of the piston pin recess 106d′. In one exemplary illustration, the circular depression 150 may be formed concurrently during the same operation that creates the lubrication recesses 112d, the recess 106d, or both. The overall shape of the depressions 150 may define at least a portion of the outer profile P′ of the lubrication recesses 112′. Thus, the depressions 150 may facilitate the formation of at least a portion of the outer profile P′ of the lubrication recesses 112′. In one example, the depressions 150 may be substantially cone shaped indentations that extend into the piston pin recess 106d′.

Referring now to FIG. 2G, a generally complete connecting rod 100 is illustrated. The connecting rod 100 now has the material flash 400 and the material flash from openings 106d and 108d (illustrated in FIG. 2D) removed by a material removal process. The material flash 400 and the material flash from openings 106d and 108d that is removed may all be generally disposed in the plane P_{F} (illustrated in FIG. 2D). In one example, the removal of the material flash from the openings 106d and 108d may be performed by a machining operation, although it is understood that other approaches may be used as well.

The piston pin bore 110 may then undergo a machining operation removing material and creating the final finish of the piston pin bore surface 110. The machining operation may substantially define the contour C of the lubrication recesses 112, while the outer profile P of the lubrication recess 112 remains generally unaffected. Moreover, the piston pin bore surface 110 may also undergo a coating operation, where at least a portion of the piston pin bore surface 110 may be coated with an anti-friction coating. The material removal process may define at least a portion of the contour C as well as the piston pin bore surface 110 (illustrated in FIG. 1C), where the contour C represents the boundary between the piston pin bore surface 110 and the lubrication recess 112.

With specific reference to FIG. 3, a process 300 for forming a connecting rod and/or assembling a piston is described. Process 300 generally begins at steps 302 to 312, where the connecting rod is initially produced or formed. In step 302, a connecting rod blank is provided. For example, the connecting rod blank 100a may include the piston pin end blank portion 102a, the crankshaft end blank portion 104a, the shaft blank portion 120a, and the generally uniform cross section X_{C}. Process 300 may then continue to step 304.

In step 304, the cross-sections of the connecting rod blank may be generally narrowed at the shaft section. For example, as described above, a roll forming operation may be employed to narrow a width W₁ of cross-section X_{C} of the initial connecting rod 100a to a reduced width W₂ of the narrowed connecting rod 100b. Furthermore, the roll forming operation may be performed generally at or around at least a portion of the shaft blank portion 120b. The narrowing of the shaft blank portion 120b also work hardens the material, thereby hardening and strengthening the narrowed portions of shaft blank portion 120b. Process 300 may then continue to step 306.

In step 306, the piston pin recess 106d and the crankshaft pin recess 108d may be formed in the connecting rod blank. For example, as described above, the piston pin recess 106d and the crankshaft pin recess 108d may be formed in the second connecting rod blank 100a in a series of forging operations as shown in FIGS. 2B-2D. FIG. 2D illustrates the recesses 106d, 108d having the material flash such that the opening does not extend all the way through the piston pin end 102d or crankshaft end 104d in an axial direction. The material flash is thus subsequently removed to form the bores 106, 108. Process 300 may then continue to step 308.

In step 308, the at least one lubrication recess 112d may be formed in the piston pin end 102d of the connecting rod blank 100d. As discussed above, the lubrication recess 112d includes an outer profile P having a final predetermined configuration, where the predetermined final configuration of the outer profile P may be substantially defined by forming the lubrication recess 112. The piston pin end 102d and the crankshaft end 104d may be generally complete, with the exception of material flash such that the opening does not extend all the way through the piston pin end 102d and the crankshaft end 104d in an axial direction.

The step 308 of forming the lubrication recess 112d may be a separate forming operation from the step 306 of forming the piston pin recess 106d. Alternatively, in another example the step 308 of forming the lubrication recess 112d may be included in the step 306 of forming of the piston pin bore 106d. That is, the lubrication recess 112d and the piston pin bore 106d may both be formed concurrently in the same forming operation. Process 300 may then continue to step 310.

In step 310, the material flash within the openings of the piston pin recess and the crankshaft recess may be removed. For example, the connecting rod blank 100d may be generally complete, with the exception of initial recesses 106d, 108d. The recesses 106d, 108d have a material flash such that the opening does not extend all the way through the piston pin end 102d or crankshaft end 104d in an axial direction. The material flash is thus subsequently removed to form the bores 106, 108. For example, the piston pin bore and the crankshaft pin bore may be machined to remove the material flash from the openings 106d and 108d, although it is understood that other approaches may be used as well.

The piston pin bore 106 may be formed in the connecting rod 100 by any combination of forming operations, such as forging operations. In other words, as described above in regard to FIGS. 2B, 2C and 2D and 2E, the piston pin bore 106 may be generally formed in a series of forging operations such as hot forging. Any other method for forming piston pin bores may be employed.

The steps 304, 306, 308 may also generally shape an initially round or circular cross-section of the connecting rod blanks 100a into a generally quadrangular cross-section. In other words, any of the forging, rolling, or other operations described herein may work a perimeter of the connecting rod blanks about the shaft 120, thus shaping an initially round cross-section of the blanks (e.g., as best seen in FIG. 2A) to a generally quadrangular cross section defining at least four generally flat sides. For example, the round cross-section initially present at FIG. 2A may be shaped into a generally I-shaped cross-section X_{F} typical of connecting rods, as seen in FIG. 1A. Other examples of generally quadrangular cross-sections may include those that are generally square, generally rectangular, or the like.

Proceeding to step 312, a material flash 400 may be removed from a perimeter of the connecting rod blank 100 after the narrowing operation. The material flash 400, as seen best in FIG. 2D, is generally disposed in a flash plane P_{F} that includes the longitudinal axis A. In other words, the flash plane P_{F} typically extends along an entire length of the pre-formed connecting rod blank, e.g., connecting rod blank 100d. Process 300 may then continue to step 314.

In step 314, the piston pin bore 110 undergoes a finishing operation, where material is removed, e.g., by machining, from the piston pin bore surface 110. For example, as described above in regard to FIG. 1C, the contour C that represents the boundary between the piston pin bore surface 110 and the lubrication recess 112 may be substantially defined in a finishing operation that removes material from the piston pin bore surface 110. By contrast, the outer profile P of the lubrication recesses 112 is generally not affected by any subsequent machining operations, such that the predetermined final configuration of the outer profile P that was substantially defined by forming of the lubrication recess 112, e.g., in step 308, remains generally the same. In other words, where the finishing operation is applied primarily to the piston pin bore surface 110, the grainflow G and the border between the lubrication recess 112 and the front face 114 of the connecting rod (e.g., as shown in FIGS. 1C and 1D) will remain generally unaffected by the finishing operation. Process 300 may then continue to step 350.

In step 350, a connecting rod is assembled with a piston. For example, as described above in regard to FIG. 1B, the connecting rod 100 may be assembled to a piston body 200 with the piston pin 202.

Accordingly, the connecting rod 100 is formed using a process 300 that requires little, if any, additional operations to the lubrication recesses 112 after forming. That is, the lubrication recesses 112 can be formed such that a separate machining operation may not be needed to further define or establish the outer profile P of the lubrication recess 112. Omitting a machining operation to the lubrication recesses 112 may reduce the complexity in manufacturing of the connecting rod.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method of manufacturing a connecting rod, comprising:
providing a connecting rod blank, where the connecting rod blank includes a crankshaft end and a piston pin end; and
forming a crankshaft pin recess in the crankshaft end of the connecting rod blank, a piston pin recess in the piston pin end, and at least one lubrication recess in the piston pin end of the connecting rod blank; and
wherein the lubrication recess and the piston pin recess are both formed concurrently.

2. The method as recited in claim 1, the at least one lubrication recess including an outer profile having a final predetermined configuration, and substantially defining the predetermined final configuration of the outer profile of the at least one lubrication recess by the forming of the piston pin recess step.

3. The method as recited in claim 1, further comprising a generally circular depression within the piston pin recess, the depression defining one of the at least one lubrication recesses and forming at least a portion of the outer profile of the lubrication recess.

4. The method as recited in claim 1, further comprising:
removing a piston pin material flash and a crankpin material flash from the piston pin recess and the crankpin recess, thereby creating a piston pin bore and a crankpin bore.

5. The method as recited in claim 4, wherein removing the piston pin flash and the crankshaft pin flash includes machining the piston pin recess and the crankshaft pin recess.

6. The method as recited in claim 4, further comprising:
coating of at least a portion of an inner surface of the piston pin bore with an anti-friction coating.

7. The method as recited in claim 1, further comprising:
removing a material flash from a perimeter of the connecting rod blank.

8. The method as recited in claim 1, further comprising:
narrowing a cross section of the connecting rod blank at a shaft section, the shaft section connecting the crankshaft end to the piston pin end.

9. The method as recited in claim 1, wherein the piston pin recess, the crankshaft pin recess and the at least one lubrication recess are formed by forging.

10. A method of manufacturing a piston, comprising:
making a connecting rod, including:
providing a connecting rod blank, where the connecting rod blank includes a crankshaft end and a piston pin end, and
forming a crankshaft pin recess in the crankshaft end of the connecting rod blank, a piston pin recess in the piston pin end of the connecting rod blank, and at least one lubrication recess at an inner surface of the piston pin recess, wherein the at least one lubrication recess includes a outer profile having a final predetermined configuration;
assembling the connecting rod to a piston, the connecting rod including the predetermined final configuration of the outer profile; and
substantially defining the predetermined final configuration of the outer profile of the at least one lubrication recess during the forming of the lubrication recess step.

11. The method as recited in claim 10, further comprising:
forming the at least one lubrication recess and the piston pin recess concurrently.

12. The method as recited in claim 10, further comprising:
the step of including a generally circular depression within the piston pin recess, the depression defining at least a portion of the outer profile of the lubrication recess.

13. The method as recited in claim 10, further comprising:
removing a piston pin material flash and a crankpin material flash from the piston pin recess and the crankpin recess to create a piston pin bore and a crankpin bore.

14. The method as recited in claim 13, wherein removing the piston pin flash and the crankshaft pin flash includes machining the piston pin recess and the crankshaft pin recess.

15. The method as recited in claim 13, further comprising:
coating at least a portion of an inner surface of the piston pin bore with an anti-friction coating.

16. The method as recited in claim 10, further comprising:
the step of removing a material flash from a perimeter of the connecting rod blank.

17. A connecting rod, comprising:
a shaft extending between a piston pin end and a crankshaft pin end, the piston pin end defining a piston pin bore opening, wherein the piston pin end includes a front face and a rear face;
a piston pin bore surface defined by the piston pin bore opening, the piston pin bore surface including a longitudinal surface extending between the front face of the piston pin and the rear face of the piston pin end; and
at least one lubrication recess located at the piston pin bore surface, the lubrication recess extending through a portion of the longitudinal surface of the piston pin bore surface,
wherein the at least one lubrication recess intersects one of the front face and the rear face of the piston pin end.

18. The connecting rod of claim 17, wherein at least the piston pin bore is constructed from a metal based material including a grain flow, wherein the grain flow at the at least one lubrication recess is oriented to generally define an outer profile of the at least one lubrication recess.

19. The connecting rod of claim 17, wherein a contour represents a boundary between the piston pin bore surface and the outer profile of one of the at least one lubrication recesses.

20. The connecting rod of claim 19, wherein the contour includes a generally tapered shape.
